(19) United States
(12) Patent Application Publication
(10) Pub. No.: US 2009/0297235 A1
(43) Pub. Date: Dec. 3, 2009

(54) IMAGE FORMING APPARATUS

(75) Inventor: Takatoshi NISHIMURA, Osaka-shi (JP)

Correspondence Address: CASELLA & HESPOS, 274 MADISON AVENUE, NEW YORK, NY, 10016, US

(73) Assignee: Kyocera Mita Corporation, Osaka-shi (JP)

(21) Appl. No.: 12/472,113

(22) Filed: May 26, 2009

(30) Foreign Application Priority Data
May 29, 2008 (JP) 2008-140251

(51) Int. Cl. G03G 15/20

(52) U.S. Cl. 399/329

(57) ABSTRACT

An image forming apparatus has heating and fixing rollers that define a fixing belt rotating path with a straight line region that runs along and faces at least an upstream part of a rotating direction of a toner image carrying belt. The upstream part of the rotating portion is upstream from a transfer position to a second roller in terms of the rotating direction of the toner image carrying belt. This arrangement reduces trapping of heat inside the main body of the apparatus, and improves the cooling efficiency of the main body of the apparatus. In addition, the toner image carrying belt and the fixer are in close proximity to each other, thereby raising the freedom of arrangement of the other constituent members, and making it possible to reduce the size of the main body of the apparatus.

### BACKGROUND OF THE INVENTION

1. Field of the Invention

The present invention relates to an image forming apparatus, and more particularly to an image forming apparatus such as an electrophotographic copying machine, a facsimile machine or a printer that is provided with a fixing unit which heats and melts unfixed toner and thereby fixing the same to a sheet (a recording medium such as paper or resin).

2. Description of the Related Art

The fixing unit of a conventional image forming apparatus based on an electrophotographic system commonly uses a heating roller fixing method in which heat sources, such as halogen lamps, are provided internally in a fixing roller of a pair of rollers which form a nip section in a conveyance path of a sheet which is carrying unfixed toner, and the toner is fixed onto the sheet by passing the sheet carrying an unfixed toner image through the nip formed by the fixing roller that is heated by the heat source, and a pressure roller.

In a heating roller fixing method of this kind, because the fixing roller is heated from the inner circumference to the outer circumference, then the heat conduction (the transfer of heat inside the same heat medium) to the surface of the roller has depended on the high heat capacity of the roller and it has taken as long time for the roller surface to heat up to the temperature required in order to carry out a fixing function (hereinafter, this time is called the “warm-up time”).

Therefore, a system has been developed in which a heating roller with an internally installed heat source is provided separately from a fixing roller, an endless fixing belt is spanned between this heating roller and the fixing roller, and an unfixed toner image is fixed onto the sheet by the nip formed between the fixing belt and the pressure roller. This system has advantages: because a fixing belt which has a small heat capacity is heated, then the heating process is quick and the warm-up time is shortened.

FIG. 6 shows an example of an image forming apparatus having a fixing belt as described above.

Referring to FIG. 6, a sheet-conveyance path 13 in which the sheet is conveyed is provided in a single horizontal line, and image forming units Pa, Pb, Pc, and Pd are disposed directly above this sheet-conveyance path 13 in the conventional composition shown in the figure.

An intermediate transfer belt 8 is incorporated into the image forming units Pa to Pd. The intermediate transfer belt 8 is wrapped tautly about a drive roller 10, an idle roller 11 and a tensioning roller 20, and is driven to rotate in the clockwise direction in accordance with the rotation of the drive roller 10 driven by a drive motor (not illustrated). The image forming units Pa to Pd transfer toner images so as to be mutually superimposed on the intermediate transfer belt 8 (primary transfer), and thus a toner image having a plurality of colors is formed on the surface of the intermediate transfer belt 8 by means of this primary transfer. The intermediate transfer belt 8 is composed so as to pass through the nip (transfer position) TP formed in the sheet-conveyance path 13 by a secondary transfer roller 9 and an idle roller 11 which are disposed between the furthest upstream image forming unit Pa and the furthest downstream image forming unit Pd, and the image which has been transferred primarily in this way is then transferred secondarily onto a sheet which passes through the transfer position TP.

The fixing unit 7 is disposed in the sheet-conveyance path 13 to the downstream side of the transfer position TP in terms of the sheet-conveyance direction. More specifically, a fixing roller 21 and a pressure roller 24 which confront each other via the sheet-conveyance path 13, a heating roller 22, and a fixing belt 23 which is spanned about the fixing roller 21 and the heating roller 22, are provided. As FIG. 6 clearly reveals, the heating roller 22 is disposed to the upstream side of the fixing roller 21, in terms of the sheet-conveyance direction Ds in the sheet-conveyance path 13. A composition in which a heating roller and a fixing belt are provided in this way can be seen in Japanese Patent No. 2769727, Japanese Patent No. 3506880, and Japanese Patent Application Laid-open No. 2005-208201.

However, in the compositions described in Japanese Patent No. 2769727 Japanese Patent No. 3506880, and Japanese Patent Application Laid-open No. 2005-208201, in other words, in the composition which is shown in principle in FIG. 6, the heating roller 22 which projects from the sheet-conveyance path 13 is disposed to the upstream side of the fixing roller 21 in terms of the conveyance direction Ds, and hence there is a risk that the heat convection (the transfer of heat between different heat media) caused by the heating roller 22 will cause adverse effects to the other units inside the main body of the apparatus. Heat effects of this kind often resolved insufficiently even by providing a cooling system in the main body of the apparatus. In particular, in recent years, further size reduction of the main body of the apparatus has been required, but depending on the arrangement of the heating roller and the fixing belt, the function of the cooling system may be impaired and it may not be possible to achieve sufficient reduction in the size of the main body of the apparatus.

On the other hand, a fixing apparatus in which a heating roller is disposed to the downstream side of the fixing roller in terms of the sheet-conveyance direction has also been proposed (see Japanese Patent Application Laid-open No. 2006-259677 and Japanese Patent Application Laid-open No. 2007-163636).

In the composition described in Japanese Patent Application Laid-open No. 2006-259677, shortening of the warm-up time and a subsequent heat retaining effect are expected due to the fact that a heat source is provided in the fixing roller as well as the heating roller, but this also leads to a marked corresponding impairment of the cooling function of the main body of the apparatus.

On the other hand, in Japanese Patent Application Laid-open No. 2007-163636, although it is stated that the heat source is covered with a housing, there is no disclosure or suggestion relating to the effects that the arrangement of the heating roller and the fixing belt may have on the cooling of the interior of the main body of the apparatus (and in particular the air flow therein). Furthermore, neither is there any disclosure nor suggestion in relation to the arrangement of the fixing apparatus with respect to the whole of the main body of the apparatus.

The present invention was devised in view of the circumstances described above, an object thereof being to provide an image forming apparatus whereby the warm-up time can be shortened, and the size of the main body of the apparatus can be reduced while taking account of maintaining cooling properties.

### SUMMARY OF THE INVENTION

One aspect of the present invention is an image forming apparatus provided with: a sheet-conveyance path in which a sheet is conveyed in a predetermined sheet-conveyance direction; an endless toner image carrying belt which carries a toner image developed from an electrostatic latent image and transfers the toner image to the sheet at a transfer position set in the sheet-conveyance path; a first roller which is located at the transfer position and rotatably guides the toner image carrying belt; a second roller disposed at a downstream side in the sheet-conveyance direction where the second roller is positioned downstream of the transfer position in the sheet-conveyance path and is distanced from the sheet-conveyance path, the second roller being tautly holding the toner image carrying belt rotatably in a predetermined rotating direction in cooperation with the first roller; a fixing roller which is facing from the toner image carrying belt side to a fixing position set to the downstream side of the transfer position in the sheet-conveyance path in terms of the sheet-conveyance direction; a fixing belt which is tautly held about the outer circumference of the fixing roller; and a heating roller which is disposed at a position distanced from the sheet-conveyance path to the toner image carrying belt side, where the heating roller tautly holds the fixing belt in conjunction with the fixing roller rotatably in a predetermined rotating direction of the fixing belt and heats the fixing roller. In this image forming apparatus, the heating and fixing rollers define a fixing belt rotating path within which a straight line region where the fixing belt faces to the toner image carrying belt runs along at least an upstream part of the rotating direction of the toner image carrying belt, the upstream part of the rotating portion is upstream side from the transfer position to the second roller in terms of the rotating direction of the toner image carrying belt. Because the straight line region of the fixing belt follows, in terms of the rotating direction, the upstream side of the path of revolution of the carrying belt in accordance with this mode, it is possible to ensure a flow path for exhaust air in the lengthwise direction of the belt, and consequently, trapping of heat inside the main body of the apparatus can be reduced, and the cooling efficiency of the main body of the apparatus can be improved. Moreover, it makes efficient to use the space of the main body of the apparatus by locating the toner image carrying belt and the fixing means in close proximity to each other and by raising the freedom of arrangement of the other constituent members, and therefore it is possible to reduce the size of the main body of the apparatus. Consequently, it is possible to reduce the size of the apparatus as well as improving the cooling efficiency in the main body of the apparatus.

These and other objects, features and advantages of the invention will become more apparent upon reading the following detailed description along with the accompanying drawings.

### BRIEF DESCRIPTION OF THE DRAWINGS

FIG. 1 is a schematic drawing showing the main composition of a tandem type color image forming apparatus relating to a first embodiment of the present invention;

FIG. 2 is a side view cross-sectional diagram showing the main composition of a tandem type color image forming apparatus relating to a second embodiment of the present invention;

FIG. 3 is a side view cross-sectional diagram showing the main composition of a tandem type color image forming apparatus relating to a third embodiment of the present invention;

FIG. 4 is a schematic drawing showing the composition of the image forming units, and the periphery of a photosensitive belt in a tandem-type color image forming apparatus relating to a fourth embodiment of the present invention;

FIGS. 5A to 5C are diagrams showing modification examples of a fixing unit used in the image forming apparatus according to the present invention; and

FIG. 6 is a side view cross-sectional diagram showing the composition of a conventional image forming apparatus.

### DETAILED DESCRIPTION OF THE PREFERRED EMBODIMENTS

Embodiments of the invention are described below in detail with reference to the drawings. In the description given below, members which are substantially the same are labeled with the same reference numerals and repeated explanation thereof is omitted.

### First Embodiment

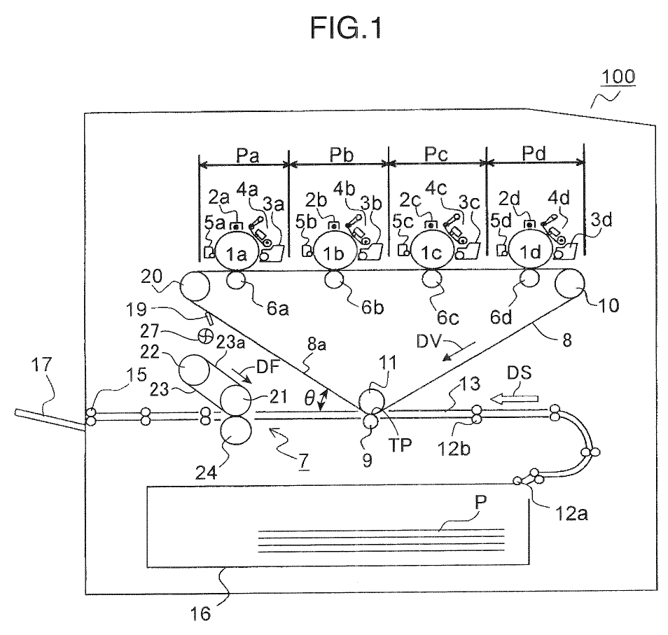

Referring to FIG. 1, in the composition shown in FIG. 1, a sheet-conveyance path 13 along which the sheet is conveyed is provided in a single horizontal line, and image forming units Pa, Pb, Pc, and Pd are disposed directly above this sheet-conveyance path 13. Four image forming units Pa, Pb, Pc, and Pd are disposed inside the main body of the image forming apparatus 100 relating to the present embodiment, in the stated order from the downstream side in terms of the sheet-conveyance direction DS (the left-hand side in FIG. 1). These image forming units Pa to Pd are provided so as to correspond to images of four different colors (magenta, cyan, yellow and black), and respectively form magenta, cyan, yellow and black images successively by means of respective steps of charging, exposure, development and transfer.

The photosensitive drums 1a, 1b, 1c, and 1d which carry visible images (toner images) of the respective colors are disposed in the image forming units Pa to Pd, and are composed in such a manner that the toner images formed on these photosensitive drums 1a to 1d are successively transferred (primary transfer) to an intermediate transfer belt 8 forming a toner image carrying body which moves adjacently to each respective image forming unit while rotating in the clockwise direction in FIG. 1 by driving means (not illustrated), whereupon the toner images are transferred (secondary transfer) together onto a sheet (recording medium) P in the secondary transfer roller 9, are fixed on the sheet P in fixing unit 7, and the sheet is then output from the main body of the apparatus. Image forming processes are executed with respect to the photosensitive drums 1a to 1d while the photosensitive drums 1a to 1d are rotated in the counter-clockwise direction in FIG. 1.

Next, the image forming units Pa to Pd are described. Charging devices 2a, 2b, 2c, and 2d which charge the photosensitive drums 1a to 1d, LED heads 4a to 4d which individually expose image information onto the photosensitive drums 1a to 1d, developing units 3a, 3b, 3c, and 3d which form toner images on the photosensitive drums 1a to 1d, and cleaning units 5a, 5b, 5c, and 5d which remove developer (toner) remaining on the photosensitive drums 1a to 1d, are provided above and about the perimeters of the photosensitive drums 1a to 1d which are freely rotatable.

When the user instructs the start of image formation, firstly, the surfaces of the photosensitive drums 1a to 1d are charged uniformly by the charging devices 2a to 2d, whereupon light is irradiated by the LED heads 4a to 4d to form electrostatic latent images corresponding to the image signal on the photosensitive drums 1a to 1d. The developing units 3a to 3d each comprise a developing roller which is provided so as to oppose the respective photosensitive drums 1a to 1d, and are respectively filled with a predetermined amount of toner of the corresponding color, magenta, cyan, yellow or black, by means of replenishment device (not illustrated). This toner is supplied to the photosensitive drums 1a to 1d by the developing rollers of the developing units 3a to 3d and adheres electrostatically to the drums, thereby forming respective toner images corresponding to the electrostatic latent images formed by the exposure from the LED heads 4a to 4d.

An electric field is applied to the intermediate transfer belt 8 at a predetermined transfer voltage, whereupon the toner images of magenta, cyan, yellow and black on the photosensitive drums 1a to 1d are primarily transferred onto the intermediate transfer belt 8 by the transfer rollers 6a to 6d. These images of four colors are formed with a predetermined positional relationship that is previously determined in order to form a predetermined full-color image. Thereupon, the toner remaining on the surfaces of the photosensitive drums 1a to 1d is removed by the cleaning units 5a to 5d in preparation for the formation of new electrostatic latent images which is be carried out subsequently.

The intermediate transfer belt 8 is formed from a dielectric resin sheet material, which is formed into an endless belt shape by bonding the respective end portions together in an overlapping fashion, or is formed into a seamless belt that is free of joints.

The intermediate transfer belt 8 is wrapped tautly about a drive roller 10 and a tensioning roller 20 which are disposed on either side in the direction in which the image forming units Pa to Pd are arranged (the left/right direction in FIG. 1), and furthermore, is tensed into an endless triangular shape bordering the sheet-conveyance path 13 by means of an idle roller 11 which is disposed between these rollers 10 and 20. In this way, the intermediate transfer belt 8 extends from the idle roller 11 toward the tensioning roller 20 in a direction away from the sheet-conveyance path 13, on the downstream side of the sheet-conveyance path 13. The intermediate transfer belt 8 is driven by the drive roller 10 and rotates in a clockwise direction (indicated by the arrow) while successively passing in the proximity of or making contact with the idle roller 11, the tensioning roller 20, the photosensitive drum 1a, the photosensitive drum 1b, the photosensitive drum 1c and the photosensitive drum 1d.

The drive roller 10 rotates toward the right in FIG. 1 due to the drive motor shown in the drawing. In accordance with this rotation, the intermediate transfer belt 8 rotates in the clockwise direction in FIG. 1. A sheet-conveyance path 13 disposed substantially in parallel with the image forming units Pa to Pd is provided directly above the intermediate transfer belt 8, and the idle roller 11 forms, together with the secondary transfer roller 9, a nip section where the sheet is sandwiched in the sheet-conveyance path (the transfer position in the present embodiment) TP. Furthermore, a cleaning blade 19 for removing toner remaining on the surface of the intermediate transfer belt 8 is disposed on the downstream side of the secondary transfer roller 9 in terms of the conveyance direction.

A sheet cassette 16 which accommodates the sheet P onto which the toner image has been transferred is provided beneath the main body of the apparatus. The sheet P in the sheet cassette 16 is conveyed to the secondary transfer roller 9 which is provided at an intermediate position of the sheet-conveyance path 13, via a paper supply roller 12a and pair of resist rollers 12b. The fixing unit 7 is disposed to the downstream side of the secondary transfer roller 9 in the sheet-conveyance path 13, in terms of the direction of conveyance of the sheet.

When the intermediate transfer belt 8 starts to rotate, the sheet P is conveyed from the resist roller 12b to the secondary transfer roller 9 at a predetermined timing, and a full-color image is transferred secondarily to the sheet P at the secondary transfer nip section (the transfer position in the present embodiment) TP which is formed by the secondary transfer roller 9 and the intermediate transfer belt 8. The sheet P to which the toner image has been transferred is conveyed to the fixing unit 7 by passing along the sheet-conveyance path 13.

In the fixing unit 7, there are provided: a fixing roller 21 which is disposed on the upper side of the sheet-conveyance path 13, a heating roller 22 which is disposed above the sheet-conveyance path 13 to the downstream side of the main body of the apparatus unit in terms of the sheet-conveyance direction and which serves to heat the fixing roller 21, a fixing belt 23 which is wrapped tautly about the heating roller 22 and the fixing roller 21, and a pressure roller 24, disposed directly below the fixing roller 21, which presses the fixing roller 21 via the fixing belt 23 and forms a fixing nip section through which the sheet P passes. The fixing roller 21 is driven by a drive apparatus (not illustrated) so as to rotate in such a manner that the circumferential speed thereof is the same as the conveyance speed of the sheet P on the sheet-conveyance path 13.

The sheet P which has been conveyed to the fixing unit 7 is subjected to heating and pressurization when passing through the fixing nip section, whereby the toner image is fixed on the surface of the sheet P and a predetermined full-color image is formed. The sheet P on which a full-color image has been formed is then output to an output tray 17 by an output roller 15.

On the other hand, in the fixing unit 7, the fixing roller 21 is composed of silicone rubber sponge constituting an elastic layer, provided on the outer side of a metal core made of aluminum, and as stated previously, the fixing roller 21 is driven by a drive apparatus (not illustrated) so as to rotate in such a manner that the circumferential speed thereof is the same as the conveyance speed of the paper P.

Furthermore, an exhaust fan 27 is provided in the rear side wall of the main body of the apparatus, whereby the heat inside the main body of the apparatus can be expelled to the exterior. Preferably, the exhaust fan 27 is disposed between the heating roller 22 and the intermediate transfer belt 8 in the rear side wall of the main body of the apparatus, for example. By disposing the exhaust fan 27 in such a position, the heating roller 22 and the intermediate transfer belt 8 are heat insulated from each other by means of an air flow.

The heating roller 22 is constituted by a round cylindrical member made of aluminum (Al), iron (Fe) or SUS (stainless steel), or the like, formed to a small material thickness, and the heating roller 22 rotates together with the fixing belt 23 in accordance with the rotation of the fixing roller 21. Apart from the metal materials described above, the round cylindrical member can also be molded using a glass material, such as quartz or phosphosilicate glass, or a resin material, such as polyimide, polyamide, or the like. A heater, such as a halogen lamp or the like, is provided on the inner side of the heating roller 22.

The fixing belt 23 is an endless belt which is composed by forming an elastic layer made of silicone rubber, fluorine resin, or the like, on the surface of a metal base body such as rolled nickel (Ni), SUS (stainless steel), or the like. There are no particular restrictions on the fixing belt 23, and apart from the foregoing, the fixing belt 23 may be constituted by a single layer consisting of a heat resistant resin, such as polyimide, for example. The fixing belt 23 is wound about the fixing roller 21 and the heating roller 22, and a predetermined tension is applied thereto.

The pressure roller 24 is made by providing silicone rubber sponge constituting an elastic member layer on the outside of a metal core made of iron, for example. The pressure roller 24 forms a fixing nip section through which the paper P is passed, by abutting against the fixing roller 21 via the fixing belt 23. Furthermore, the pressure roller 24 rotates in accordance with the rotation of the fixing roller 21.

The heating roller 22 is disposed to the downstream side of the fixing roller 21 in terms of the direction of conveyance of the sheet. Out of the region of rotation of the fixing belt 23 on the side toward the secondary transfer roller 9 with respect to the fixing roller 21 and the heating roller 22 (the right-hand side in FIG. 1), if the straight line region thereof which runs alongside the intermediate transfer belt 8 is taken as the straight line path 23a, and if the upstream side path of revolution of the intermediate transfer belt 8 after passing the secondary transfer position TP is taken as the movement path 8a, then the straight line path 23a is provided so as to follow (and preferably, lie parallel to) the movement path 8a of the intermediate transfer belt 8 (this layout relationship of the straight line path 23a and the movement path 8a is also called a “spaced layout”).

By adopting a spaced layout of this kind, the heating roller 22 which radiates the greatest amount of heat can be distanced from the interior of the main body of the apparatus, such as the intermediate transfer belt 8, the secondary transfer nip section TP and the image forming units Pa to Pd, and so on. By this means, it is possible to prevent the heat generated by the heating roller 22 from becoming trapped inside the main body of the apparatus. Moreover, the spaced layout makes it possible to ensure that the exhaust air flow path (one example of heat insulating means) created by the exhaust fan 27 extends in the lengthwise direction of the fixing belt, and therefore it is possible to restrict increase in the temperature inside the main body of the apparatus, as well as being able to shorten the heat expulsion path created by the exhaust fan 27, and thus improving the cooling efficiency of the exhaust fan 27. Furthermore, by means of the spaced layout, an “air curtain” is formed between the intermediate transfer belt 8 and the fixing belt 23, thereby heat isolating the fixing unit 7 and preventing the heat convection to the units of in the main body of the apparatus. In particular, if the straight line path 23a is provided in parallel with the straight line-shaped movement path 8a, then it is possible to raise the flux density of the exhaust air flowing in the exhaust air flow channel, and therefore a merit is obtained in that heat effects are not liable to be felt even if the apparatus is reduced in size.

Furthermore, by ensuring an air flow by means of the spaced layout, the space of the main body of the apparatus can be utilized efficiently in that the intermediate transfer belt 8 and the fixing unit 7 can be located as close as possible to each other, and the freedom of layout of the other constituent members, and the like, can be improved, and therefore it is possible to reduce the size of the main body of the apparatus. Consequently, according to the present embodiment, it is possible to reduce the size of the apparatus at the same time as improving the cooling efficiency in the main body of the apparatus.

However, there are no particular restrictions on the arrangement of the straight line path 23a, provided that it follows the direction of arrangement of the straight line-shaped movement path 8a. Generally, it is preferable that the angle θ of the straight line-shaped movement path 8a with respect to the conveyance path 13 should be 30° to 60°, and therefore it is preferable that the angle of the straight line path 23a with respect to the conveyance path 13 should also be 30° to 60°.

In the present embodiment, the outer diameter of the heating roller 22 is approximately the same size as the outer diameter of the fixing roller 21, but these dimensions are not subject to particular restrictions and it is possible to set the outer diameters of the heating roller 22 and the fixing roller 21 appropriately in accordance with the composition of the apparatus, and so on. For example, it is also possible to make the outer diameter of the heating roller 22 smaller or larger than the outer diameter of the fixing roller 21.

Furthermore, in the present embodiment, the intermediate transfer belt 8 is wrapped tautly about the three rollers described above, but there are no particular restrictions on the number of rollers about which the intermediate transfer belt 8 is wrapped, or their arrangement, or the like, for instance, two rollers or four or more rollers may be employed, provided that they enable a spaced layout.

### Second Embodiment

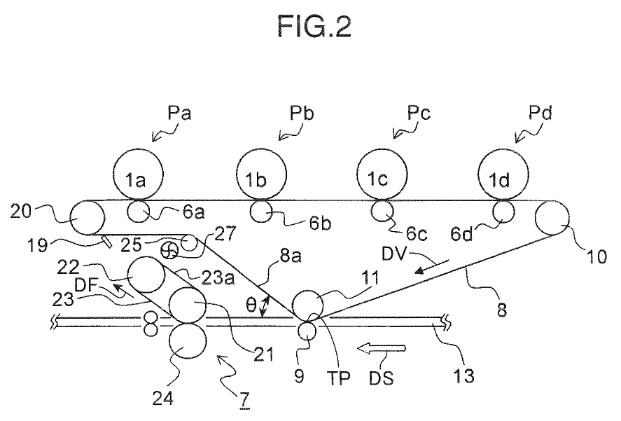

FIG. 2 is a schematic drawing showing the composition of the image forming units, the intermediate transfer belt and the periphery of the fixing unit in a tandem-type color image forming apparatus relating to a second embodiment of the present invention.

In the second embodiment, a bend roller 25 is provided between the idle roller 11 and the tensioning roller 20, and the outer circumferential surface of the intermediate transfer belt 8 opposing the fixing belt 23 is pressed toward the inner circumferential side of the belt, thereby forming a dog-leg shaped space where the intermediate transfer belt 8 bends toward the inner circumferential side. The intermediate transfer belt 8 is driven by the drive roller 10 and rotates in a clockwise direction (indicated by the arrow) while successively passing in the proximity of or making contact with the idle roller 11, the bend roller 25, the tensioning roller 20, the photosensitive drum 1a, the photosensitive drum 1b, the photosensitive drum 1c and the photosensitive drum 1d. Apart from this, the composition is the same as that of the first embodiment.

According to the second embodiment, it makes efficient to use the space formed by bending the intermediate transfer belt 8, for instance, by reducing the space occupied by the intermediate transfer belt 8 in the apparatus as a whole, or improving the freedom of layout of the other constituent members, and therefore further reduction in the size of the apparatus can be achieved. Furthermore, it is also possible to impart a stable tension to the intermediate transfer belt 8.

Moreover, in the present embodiment, if the path of revolution of the intermediate transfer belt 8 between the tensioning roller 20 and the bend roller 25 is formed as a dog-leg shaped movement path 8a, then the straight line path of this movement path 8a from the bend roller 25 to the tensioning roller 20 is disposed (horizontally) substantially in parallel with the plane which contains the primary transfer nip sections formed by the photosensitive drums 1a to 1d and the transfer rollers 6a to 6d. By this means, it makes more efficient use of the space of the main body of the apparatus, and therefore the main body of the apparatus can be further reduced in size.

However, there are no particular restrictions on the arrangement position of the bend roller 25, provided that it presses the outer circumferential surface of the intermediate transfer belt 8 opposing the fixing belt 23 toward the inner circumferential side of the intermediate transfer belt 8, thereby causing the intermediate transfer belt 8 to bend toward the inner circumferential side, as well as enabling the upstream side of the movement path 8a to lie substantially in parallel with the straight line path 23a of the fixing belt 23. Furthermore, it is also possible to set the amount of bending of the intermediate transfer belt 8 to a suitable amount in accordance with the composition of the main body of the apparatus, and the like.

### Third Embodiment

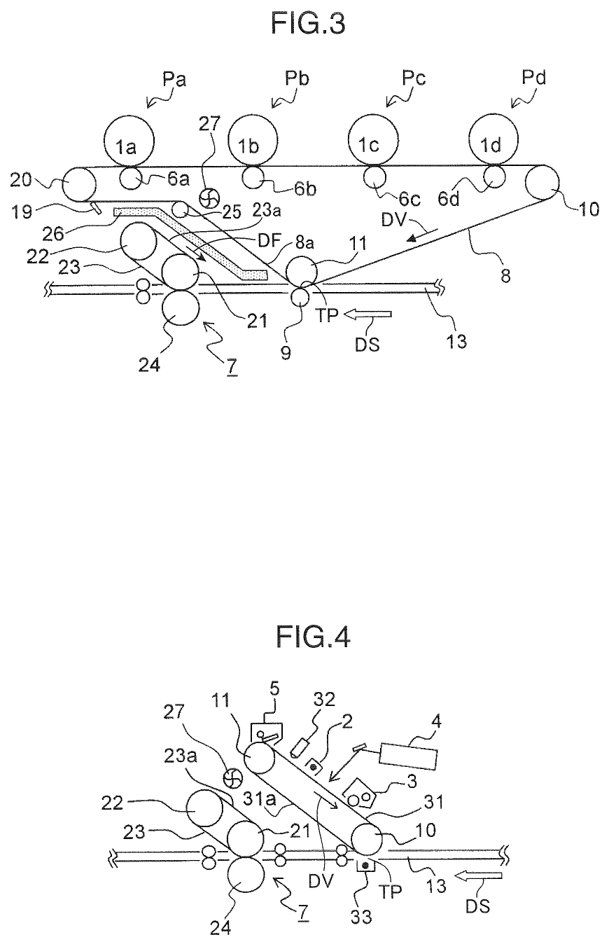

Referring now to FIG. 3, in the third embodiment according to the present invention, a duct 26 forming heat insulating means is provided between the fixing unit 7 and the intermediate transfer belt 8 so as to follow the intermediate transfer belt 8, from the region above the heating roller 22 to the fixing roller 21. Furthermore, the duct 26 is made of a hollow member inside which an air flow can pass, and the air flow generated inside the main body of the apparatus by an exhaust fan 27 can be expelled from the rear surface of the main body of the apparatus by the exhaust fan 27, by passing inside the duct 26 in a direction perpendicular to the plane of the drawing. Apart from this, the composition is the same as that of the second embodiment.

By means of this composition, transfer of heat between the fixing unit 7 and the intermediate transfer belt 8 is suppressed, while at the same time the cooling efficiency of the main body of the apparatus can be improved further by the passage of an air flow inside the duct 26. Moreover, the size of the main body of the apparatus can be reduced and the related cooling efficiency can be improved. The material used for the duct 26 may be metal, resin, or the like, and is not subject to any particular restrictions.

In this respect, metal has high heat-coefficient conductivity and resin has low heat-coefficient conductivity. Consequently, if the duct 26 is made of metal, for example, then the heat generated by the heating roller 22 is absorbed by the duct 26 and this absorbed heat can be radiated swiftly by contact with the air flow passing inside the duct 26. Therefore, it is possible further to improve the cooling efficiency of the main body of the apparatus. On the other hand, if the duct 26 is made of resin, then it is possible to prevent the heat generated by the heating roller 22 and the fixing unit 7 from being transmitted to the interior of the main body of the apparatus, and therefore it is possible further to improve the cooling efficiency of the main body of the apparatus.

Furthermore, in the present embodiment, because a bend roller 25 is provided similarly to the second embodiment, then the duct 26 can be provided in the space created by the bending of the intermediate transfer belt 8. In this way, the presence of the duct 26 does not lead to an increase in the size of the main body of the apparatus. Furthermore, in the present embodiment, a duct 26 is provided from a position opposing the heating roller 22 to a position opposing the fixing roller 21, and therefore the cooling efficiency of the main body of the apparatus can be improved further.

However, there are no particular restrictions on the composition and arrangement of the duct 26, provided that an air flow can pass inside same and provided that it is disposed between the fixing unit 7 and the intermediate transfer belt 8. For example, the duct 26 can also be formed to a size and shape whereby it can be provided only in the periphery of the heating roller 22, or only in a position opposing the straight line path 23a of the fixing belt 23 and the movement path 8a of the intermediate transfer belt 8. Furthermore, a duct 26 can also be provided in the image forming apparatus according to the first embodiment which was described above, for example. Preferably, the duct 26 extends throughout the whole of the upstream side from the cleaning blade 19, in the rotating direction DV of the intermediate transfer belt 8. In this case, the risk of residual toner on the intermediate transfer belt 8 being affected by heat before it is removed by the cleaning blade 19 is further reduced.

Furthermore, in the embodiment described above, the idle roller 11 was taken as a first taut holding roller and the tensioning roller 20 was taken as a second taut holding roller, but the invention is not limited to this composition, and either of the rollers may be taken as the first and second taut holding rollers, depending on the composition of the apparatus, and so on. Furthermore, in the present embodiment, an intermediate transfer belt 8 was used, but the belt carrying the toner image is not limited in particular to an intermediate transfer belt. Apart from this, it is also possible to adopt a composition using a photosensitive belt as the belt carrying the toner image.

### Fourth Embodiment

FIG. 4 is a schematic drawing showing the composition of the image forming units, and the periphery of a photosensitive belt in a tandem-type color image forming apparatus relating to a fourth embodiment of the present invention. In the fourth embodiment, a photosensitive belt 31 which is wrapped tautly about a drive roller (first taut holding roller) 10 and an idle roller (second taut holding roller) 11 is used as the belt carrying the toner image. Furthermore, a cleaning unit 5, a charge removing unit 32, a charging device 2, an exposure unit (LSU) 4 and a developing unit 3 are provided in this order from the upstream side of the rotating direction DV of the belt, at positions opposing the photosensitive belt 31 to the upstream side of the driver roller 10 and the idle roller 11 in terms of the sheet-conveyance direction DS.

Furthermore, a discharge type transfer device (transfer means) 33 is disposed at a predetermined gap from the photosensitive belt 31, at a position opposing the drive roller 10 via the photosensitive belt 31, thereby providing a transfer position TP in the sheet-conveyance path 13. By this means, the electrostatic latent image formed on the photosensitive belt 31 by the exposure unit 4 is developed by the developing unit 3, and the toner image on the photosensitive belt 31 can then be transferred to a sheet P conveyed in the conveyance path 13, by the transfer device 33, at the transfer position TP. If the straight line portion of the rotating direction DV after passing the transfer position TP is taken as the straight line-shaped movement path 31a, then the straight line path 23a of the fixing belt 23 is disposed substantially in parallel with this straight line-shaped movement path 31a. The remainder of the composition is the same as that of the first embodiment and therefore further description thereof is omitted here.

### Further Modification Examples

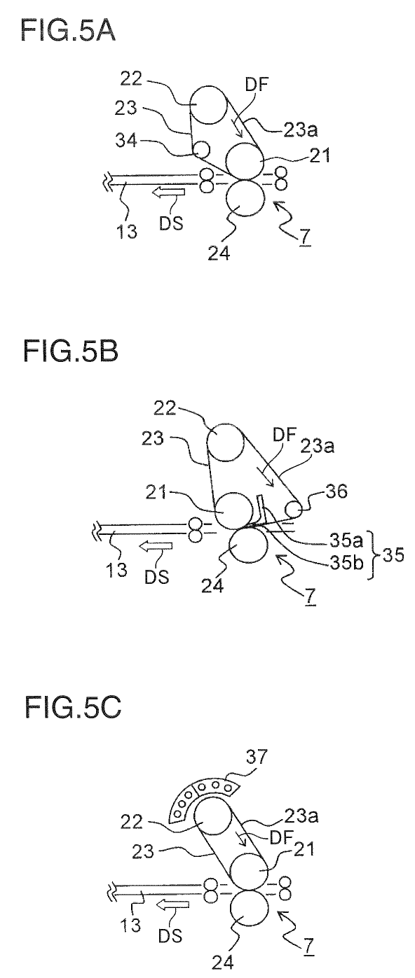

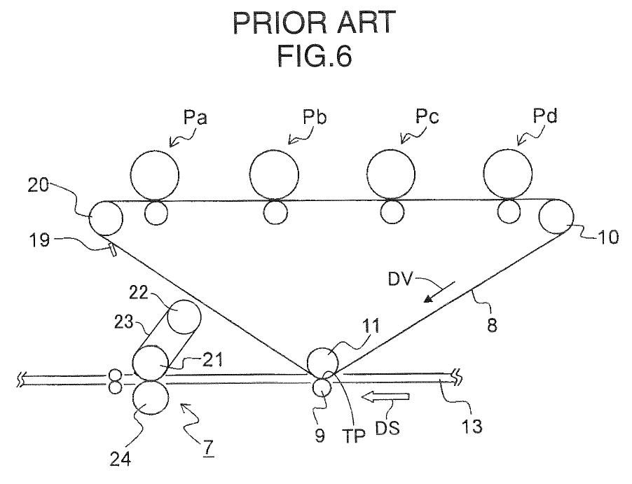

Furthermore, in the fourth embodiment, the fixing belt 23 is tautly held about the fixing roller 21 and the heating roller 22, but the composition of the fixing unit 7 is not limited in particular to the embodiment described above. FIG. 5A, FIG. 5B and FIG. 5C are diagrams showing modification examples of a fixing unit used in the image forming apparatus according to the present invention. For example, it is possible to use three or more rollers for tautly holding the fixing belt 23, such as a composition where a tensioning roller 34 is provided between the fixing roller 21 and the heating roller 22, on the downstream side in the sheet-conveyance direction DS (the left-hand side in the drawings), as shown in the fixing unit 7 shown in FIG. 5A.

Moreover, it is also possible to dispose a guide roller 36 between the heating roller 22 and the fixing roller 21, on the upstream side in the sheet-conveyance direction DS (the right-hand side in the drawings), as shown in FIG. 5B. In FIG. 5B, a complementary pressing member 35 which comprises a main pressing section 35a that abuts against the pressure roller 23 via the fixing belt 23 and a complementary extending section 35b that extends from the main pressing section 35a to the fixing nip section, is provided on the upstream side of the fixing roller 21 in terms of the direction of rotation DF of the fixing belt 23.

Furthermore, a guide roller 36 which makes internal contact with the fixing belt 23 is provided on the upstream side of the complementary pressing member 35. By this means, it is possible to ensure a sufficient nip time, as well as preventing the occurrence of partial non-uniformities in the pressure. In a composition of this kind, it is possible to form the portion between the guide roller 36 and the heating roller 22 as the straight line path (straight line region) 23a of the fixing belt 23.

Furthermore, the method of heating the heating roller 22 is not limited in particular to a halogen heater as described above, and apart from this, it is also possible to adopt a composition in which an induction heating coil (IH coil) 37 is provided opposing the heating roller 22, as shown in FIG. 5C, and the heating roller 22 is heated by passing a high-frequency current through the induction heating coil.

Apart from this, the present invention is not limited to the embodiments described above, and may be modified within a scope that does not depart from the essence of the present invention. For example, in FIG. 1, it is also possible to dispose the image forming units Pa to Pd, the intermediate transfer belt 8 and the fixing belt 23 below the conveyance path 13, and to dispose the secondary transfer roller 9 and the pressure roller 24 above the conveyance path 13. Moreover, in the embodiment described above, for example, the image forming units Pa to Pd and the conveyance path 13 were disposed in the horizontal direction, but their arrangement is not subject to any particular restrictions and apart from this, it is also possible to dispose same in an oblique direction or vertical direction.

Furthermore, in the present embodiment, an exhaust fan 27 is disposed in the rear side wall of the main body of the apparatus, but there are no particular restrictions on the positioning of the exhaust fan 27. By disposing the exhaust fan 27 between the image forming units Pa to Pd and the heating roller 22, it is possible to improve the cooling efficiency inside the main body of the apparatus, and it is also possible to raise the cooling efficiency as the exhaust fan 27 is located higher. Consequently, it is possible to set the position by taking these factors into consideration, for instance.

Moreover, in the embodiment described above, the photosensitive drums 1a to 1d were disposed in such a manner that the primary transfer nip sections lie in substantially the same plane, but the arrangement is not subject to particular restrictions and may be set appropriately in accordance with the composition of the apparatus, or the like. Furthermore, the embodiments described above relate to application to a color printer as an image forming apparatus, but the present invention can also be applied in an entirely similar fashion to a color duplicating machine, fax machine, or the like.

As described above, one aspect of the present invention is an image forming apparatus provided with: a sheet-conveyance path in which a sheet is conveyed in a predetermined sheet-conveyance direction; an endless toner image carrying belt which carries a toner image developed from an electrostatic latent image and transfers the toner image to the sheet at a transfer position set in the sheet-conveyance path; a first roller which is located at the transfer position and rotatably guides the toner image carrying belt; a second roller disposed at a downstream side in the sheet-conveyance direction where the second roller is positioned downstream of the transfer position in the sheet-conveyance path and is distanced from the sheet-conveyance path, the second roller being tautly holding the toner image carrying belt rotatably in a predetermined rotating direction in cooperation with the first roller; a fixing roller which is facing from the toner image carrying belt side to a fixing position set to the downstream side of the transfer position in the sheet-conveyance path in terms of the sheet-conveyance direction; a fixing belt which is tautly held about the outer circumference of the fixing roller; and a heating roller which is disposed at a position distanced from the sheet-conveyance path to the toner image carrying belt side, where the heating roller tautly holds the fixing belt in conjunction with the fixing roller rotatably in a predetermined rotating direction of the fixing belt and heats the fixing roller. In this image forming apparatus, the heating and fixing rollers define a fixing belt rotating path within which a straight line region where the fixing belt faces to the toner image carrying belt runs along at least an upstream part of the rotating direction of the toner image carrying belt, the upstream part of the rotating portion is upstream side from the transfer position to the second roller in terms of the rotating direction of the toner image carrying belt (spaced layout).

According to this embodiment, the sheet which is subjected to an image forming process is conveyed along a sheet conveyance path, while a toner image is developed from an electrostatic latent image and is carried out a toner image carrying belt. The toner image carrying belt may be a photosensitive belt or it may also be an intermediate transfer belt which to which a toner image is transferred from a photosensitive belt. The toner image is transferred to the sheet when the sheet conveyed along the sheet conveyance path passes through the transfer position formed by the transfer means and the toner image carrying belt. The toner image transferred onto the sheet is heated and fixed to the sheet by passing between the fixing belt and the pressure roller. In the process described above, the fixing belt is heated by a heating roller. This could be cause the heat convection to the air inside the main body of the apparatus. The spaced layout, however, makes it possible to ensure a flow path for exhaust air in the lengthwise direction of the fixing belt, and therefore it is possible to reduce the trapping of heat inside the main body of the apparatus and to raise the cooling efficiency of the main body of the apparatus. In addition, it is possible to make efficient use of the space of the main body of the apparatus, for instance, by locating the toner image carrying belt and the fixing means in close proximity to each other and by raising the freedom of arrangement of the other constituent members, and therefore it is possible to reduce the size of the main body of the apparatus. Consequently, it is possible to reduce the size of the apparatus as well as improving the cooling efficiency in the main body of the apparatus.

In a preferable embodiment, the image forming apparatus further provided with: heat insulating means which is formed between the fixing belt and the toner image carrying belt, and insulates heat convection caused by the fixing belt. According to this embodiment, by means of the heat insulating means, it is possible further to prevent the heat transmitted by the heating roller and the fixing roller from being transferred to the toner image carrying belt and the various devices which form an image on the toner image carrying belt. The heat insulating means may be an air flow. In particular, image forming apparatuses generally employ a composition in which an exhaust fan is provided and air is introduced into the apparatus from outside and heated air is expelled from the apparatus, but if a portion of this exhaust air flow path is formed between the fixing belt and the toner image carrying belt, then it is possible for make the air flow function as an air shutter. Consequently, according to the present embodiment, it is possible to shorten the warm-up time, maintain cooling properties, and reduce the size of the main body of the apparatus. As mentioned above, the heat insulating means can be various forms: it may be not only members made of metal, resin, or any other tangible materials, but may also be fluid such as an air curtain. Simple plate or a solid porous resin may also be employed as the heat insulating means.

In a preferable embodiment, the heat insulating means includes a hollow duct which is disposed between the fixing belt and the toner image carrying belt and allows an air flow therethrough. According to this embodiment, it is possible further to improve the cooling efficiency of the main body of apparatus, while achieving size reduction of the main body of the apparatus. The heat conduction coefficient (W/(m·k)) is higher in a solid (for example, 0.237 at 30° C. in the case of resin), than air (0.0257 at 40° C., for example). Therefore, the heat from the fixing unit can be absorbed rapidly by the duct itself, and furthermore the heat absorbed by the duct can be transmitted readily into the air flow inside the duct. Moreover, the heat passed into the duct is output efficiently to the exterior of the apparatus by the air flow inside the duct. Therefore, it is possible further to improve the cooling efficiency of the main body of the apparatus.

In a preferable embodiment, the duct is disposed at a position opposing at least a region from the heating roller to the fixing roller. According to this embodiment, by ensuing the heat absorbing capacity and the air flow volume of the duct, even better heat insulating performance is displayed and the cooling efficiency of the main body of the apparatus can be improved further.

In a preferable embodiment, the duct is made of metal. According to this embodiment, it is possible to promote the transfer of heat from the outside to the inside of the duct, and therefore the cooling efficiency can be improved.

In another embodiment, the duct is made of resin. According to this embodiment, by utilizing the heat insulating properties of the resin, it is possible to prevent the heat of the fixing unit from being transmitted to the image forming unit.

A preferable embodiment is further provided with a bend roller which is provided between the first and second rollers so as to press the toner carrying belt from outer circumferential side and to bend the toner carrying belt from the downstream side in terms of the sheet-conveyance direction toward the upstream side of the sheet-conveyance path, thereby bending the toner image carrying belt of which a rotating path has a portion from the bend roller to the second roller which runs along the downstream side of the sheet-conveyance path so as to surround the heating roller. The duct extends along a region from the transfer position to the second roller defined by a portion of the rotating path of the toner image carrying belt. According to this embodiment, it is possible to reduce the size of the whole apparatus, as well as improving the cooling efficiency further by increasing the amount of heat removed via the duct.

In a preferable embodiment, the straight line region of the fixing belt is substantially parallel to the rotating path of the toner image carrying belt defined by the bending roller and the first roller. According to this embodiment, it is also possible to make efficient use of the space which is formed by the bending of the toner image carrying belt, and therefore further size reduction of the apparatus can be achieved.

In a preferable embodiment, the heat insulating means includes an exhaust fan which forms an air flow between the toner image carrying belt and the fixing belt. According to this embodiment, it is possible to ensure the flow path of the cooling air, in conjunction with the spaced layout. Moreover, because the spaced layout makes it possible to ensure an air flow throughout substantially the whole length of the region between the heating roller and the fixing roller, then it is possible to achieve both countermeasures against heat and size reduction, without unnecessarily increasing the number of members with respect to existing apparatuses. Furthermore, by means of the spaced layout, the flux density of the cooling air flow is increased, and no effects of heat are felt, even if the apparatus is reduced in size.

A preferable embodiment is further provided with a bend roller which is provided between the first and second rollers so as to press the toner carrying belt from outer circumferential side and to bend the toner carrying belt from the downstream side in terms of the sheet-conveyance direction toward the upstream side of the sheet-conveyance path, thereby bending the toner image carrying belt of which a rotating path has a portion from the bend roller to the second roller which runs along the downstream side of the sheet-conveyance path so as to surround the heating roller. According to this embodiment, the outer circumferential surface of the toner image carrying belt which opposes the fixing belt is pressed toward the inner circumferential side of the belt, and the space created by the subsequent bending of the toner image carrying belt can be used more efficiently, thus making it possible to achieve further size reduction of the apparatus. Furthermore, it is also possible to impart a stable tension to the toner image carrying belt.

In another preferable embodiment, the straight line region of the fixing belt is substantially parallel to the rotating path of the toner image carrying belt defined by the bending roller and the first roller for taut holding.

In another preferable embodiment, the straight line region of the fixing belt is set to be parallel to an intermediate portion of the upstream side in terms of the rotating direction, of the rotating path of the toner image carrying belt. According to this embodiment, it is possible to raise the flux density of the exhaust air flowing in the exhaust air flow path by setting the straight line region of the fixing belt to be parallel to the intermediate portion of the upstream side in terms of the rotating direction, of the rotating path of the toner image carrying belt, and therefore a merit is obtained in that the effects of heat are not liable to be felt, even if the apparatus is reduced in size. Consequently, it is possible to locate the fixing belt and the toner image carrying belt in closest possible proximity to each other, and therefore the freedom of arrangement of the other constituent members is increased, and further size reduction of the main body of the apparatus is possible.

### INDUSTRIAL APPLICABILITY

The present invention can be used appropriately in copying machines, facsimile machines, digital printers, and machines combining these, and the like. According to the present invention, it is possible to dispose a heating roller to the outside of the main body of the apparatus, and hence trapping of heat inside the main body of the apparatus is prevented and the cooling efficiency of the main body of the apparatus is improved, in addition to which the space of the main body of the apparatus can be utilized efficiently and the main body of the apparatus can be reduced in size, thus making it possible to achieve size reduction while also improving the cooling efficiency of the main body of the apparatus.

This application is based on Japanese patent application serial No. 2008-140251, filed in Japan Patent Office on May 29, 2008, the contents of which is hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An image forming apparatus, comprising:
a sheet-conveyance path in which a sheet is conveyed in a predetermined sheet-conveyance direction;
an endless toner image carrying belt which carries a toner image developed from an electrostatic latent image and transfers the toner image to the sheet at a transfer position set in the sheet-conveyance path;
a first roller which is located at the transfer position and rotatably guides the toner image carrying belt;
a second roller disposed at a downstream side in the sheet-conveyance direction where the second roller is positioned downstream of the transfer position in the sheet-conveyance path and is distanced from the sheet-conveyance path, the second roller being tautly holding the toner image carrying belt rotatably in a predetermined rotating direction in cooperation with the first roller;
a fixing roller which is facing from the toner image carrying belt side to a fixing position set to the downstream side of the transfer position in the sheet-conveyance path in terms of the sheet-conveyance direction;
a fixing belt which is tautly held about the outer circumference of the fixing roller; and
a heating roller which is disposed at a position distanced from the sheet-conveyance path to the toner image carrying belt side, where the heating roller tautly holds the fixing belt in conjunction with the fixing roller rotatably in a predetermined rotating direction of the fixing belt and heats the fixing roller,
wherein the heating and fixing rollers define a fixing belt rotating path within which a straight line region where the fixing belt faces to the toner image carrying belt runs along at least an upstream part of the rotating direction of the toner image carrying belt, the upstream part of the rotating portion is upstream side from the transfer position to the second roller in terms of the rotating direction of the toner image carrying belt.

2. The image forming apparatus according to claim 1, further comprising heat insulating means which is formed between the fixing belt and the toner image carrying belt, and insulates heat convection caused by the fixing belt.

3. The image forming apparatus according to claim 2, wherein the heat insulating means includes a hollow duct which is disposed between the fixing belt and the toner image carrying belt and allows an air flow therethrough.

4. The image forming apparatus according to claim 3, wherein the duct is disposed at a position opposing at least a region from the heating roller to the fixing roller.

5. The image forming apparatus according to claim 3, wherein the duct is made of metal.

6. The image forming apparatus according to claim 3, wherein the duct is made of resin.

7. The image forming apparatus according to claim 3, further comprising a bend roller which is provided between the first and second rollers so as to press the toner carrying belt from outer circumferential side and to bend the toner carrying belt from the downstream side in terms of the sheet-conveyance direction toward the upstream side of the sheet-conveyance path, thereby bending the toner image carrying belt of which a rotating path has a portion from the bend roller to the second roller which runs along the downstream side of the sheet-conveyance path so as to surround the heating roller,
wherein the duct extends along a region from the transfer position to the second roller defined by a portion of the rotating path of the toner image carrying belt.

8. The image forming apparatus according to claim 7, wherein the straight line region of the fixing belt is substantially parallel to the rotating path of the toner image carrying belt defined by the bending roller and the first roller.

9. The image forming apparatus according to claim 2, wherein the heat insulating means includes an exhaust fan which forms an air flow between the toner image carrying belt and the fixing belt.

10. The image forming apparatus according to claim 1, further comprising: a bend roller which is provided between the first and second rollers so as to press the toner carrying belt from outer circumferential side and to bend the toner carrying belt from the downstream side in terms of the sheet-conveyance direction toward the upstream side of the sheet-conveyance path, thereby bending the toner image carrying belt of which a rotating path has a portion from the bend roller to the second roller which runs along the downstream side of the sheet-conveyance path so as to surround the heating roller.

11. The image forming apparatus according to claim 10, wherein the straight line region of the fixing belt is substantially parallel to the rotating path of the toner image carrying belt defined by the bending roller and the first roller for taut holding.

12. The image forming apparatus according to claim 1, wherein the straight line region of the fixing belt is set to be parallel to an intermediate portion of the upstream side in terms of the rotating direction, of the rotating path of the toner image carrying belt.
